(19) United States
(12) Patent Application Publication
(10) Pub. No.: US 2009/0325050 A1
(43) Pub. Date: Dec. 31, 2009

(54) Power source and electronic device assembly

(75) Inventors: Thomas K. Bluhm, Munson Township, OH (US); Terrence M. Adams, Kirtland, OH (US)

Correspondence Address: James A. Hudak, Esq., Suite #304, 29425 Chagrin Blvd., Cleveland, OH, 44122, US

(73) Assignee: Channel Products, Inc.

(21) Appl. No.: 12/215,418

(22) Filed: Jun. 27, 2008

(51) Int. Cl. H01M 2/10

(52) U.S. Cl. 429/100; 429/99

(57) ABSTRACT

An assembly comprising a casing for a power source and an associated electronic device is disclosed. The casing receives at least one dry cell battery and an electrical conductor having a contact spring portion that engages the bottom-most battery. The upper end of the casing has threads provided thereon which engage threads within the electronic device. A centrally located terminal in the electronic device engages the negative terminal on the upper-most battery and one of its oppositely disposed interconnected terminals engage the terminal end portion of the electrical conductor whose contact spring portion engages the negative terminal on the bottom-most battery. By inserting the open end of the casing into a recess in the electronic device and then rotating the casing by about 90 degrees with respect to the electronic device, the threads on the casing engage the threads on the electronic device securing the casing to the electronic device and causing the negative terminal on the upper-most battery in the casing to engage the central terminal in the electronic device and causing the terminal end portion of the electrical conductor whose contact spring portion engages the positive terminal on the bottom most-battery in the casing to engage one of the oppositely disposed interconnected terminals in the electronic device. The structure of the casing permits the easy removal and replacement of same with respect to the electronic device and also provides an overall assembly that is sealed to the environment and is watertight and submersible.

### TECHNICAL FIELD

The present invention relates, in general, to an assembly comprising a housing for a power source and an associated electronic device and, more particularly, to such an assembly wherein the housing for the power source can be readily and easily changed and the assembly is environmentally sealed to weather conditions and is watertight and submersible.

### BACKGROUND ART

Electronic devices for an appliance may be powered by dry cell batteries. These electronic devices are usually mounted on the underside of the appliance and are not visible unless one looks under the appliance. The batteries for these electronic devices are usually received within a recess in the device. Since the electronic device is mounted on the underside of the appliance and is not visible unless one looks under the appliance, replacement of the batteries is a relatively difficult task since the person replacing the batteries must go under the appliance in order to remove and replace same. In addition, the person removing the batteries may have to use some type of gripping device, such as a pair of pliers, to remove the electronic device from its mounting panel and to grip the batteries in order to remove same. Thus, the replacement of batteries in electronic devices presently utilized on appliances is very cumbersome and time consuming. In addition, the batteries and the electronic devices may not be sealed to the environment.

In view of the foregoing, it has become desirable to develop an assembly comprising a housing for a power source and an associated electronic device for an appliance wherein the housing for the power source can be easily removed and replaced, and wherein the overall assembly is sealed to the environment.

### SUMMARY OF THE INVENTION

The present invention solves the problems with prior art assemblies involving housings for power sources and their associated electronic devices, and other problems, by providing a housing for a power source that can be readily removed and replaced without the use of tools and wherein the overall assembly of the housing and its associated electronic device is sealed to the environment. The housing for the power source of the present invention is comprised of a casing member that receives at least one dry cell battery and an electrical conductor having a contact spring portion that engages the positive terminal of the bottom-most battery adjacent the closed end of the casing member and an oppositely disposed terminal end portion that contacts one of oppositely disposed interconnected terminals in the electronic device. The oppositely disposed open end of the casing member has male threads provided thereon which engage male threads within the electronic device. A centrally located terminal in the electronic device engages the negative terminal on the upper-most battery. By inserting the end of the casing member into a recess in the electronic device and then rotating the casing member through 90 degrees with respect to the electronic device, the threads on the end of the casing member engage the threads within the electronic device securing the casing member to the electronic device and causing the negative terminal on the upper-most battery in the casing member to engage the central terminal in the electronic device and also causing the contact spring that engages the positive terminal on the bottom-most battery in the casing member to engage one of the oppositely disposed interconnected terminals in the electronic device. The structure of the casing member containing the batteries is such that engagement of the casing member with the electronic device can be made when these components are as much as 180 degrees out of angular alignment by rotating the casing member by 90 degrees with respect to the electronic device. Such rotation results in full mechanical and electrical engagement, including the frictional locking engagement, of the casing member with the electronic device while also providing an indication that full engagement for sealing purposes has been effected.

### BRIEF DESCRIPTION OF THE DRAWINGS

FIG. 1 is a front elevation view of the casing member of the present invention.

FIG. 2 is a cross-sectional view of the casing member of the present invention shown in FIG. 1.

FIG. 3 is a bottom plan view of an electronic device that can be threadably attached to the casing member of the present invention to form an overall assembly.

FIG. 4 is a front elevation view of the casing member of the present invention taken adjacent its open end portion.

FIG. 5 is a cross-sectional view of an electronic device that can be threadably attached to the casing member of the present invention to form an overall assembly.

### DESCRIPTION OF THE PREFERRED EMBODIMENT

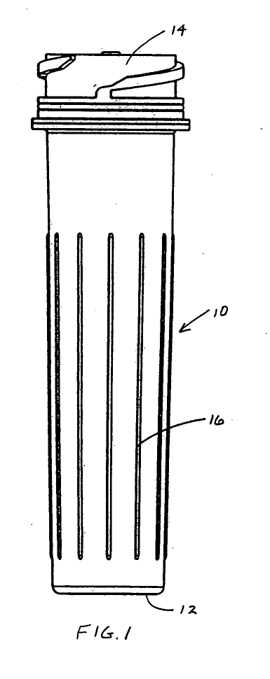

Referring now to the drawings where the illustrations are for the purpose of describing the preferred embodiment of the present invention and are not intended to limit the invention described herein, FIG. 1 is a front elevation view of the casing member 10 of the present invention. The casing 10, which can be made from any one of a number of injection moldable plastic materials, may be tubular in configuration and have a closed end 12 and an oppositely disposed open end 14. The overall length of casing 10 is sufficient to accommodate at least one dry cell battery and the inner diameter thereof is sized to receive such batteries. A plurality of spaced-apart longitudinally extending ribs 16 are provided on the outer surface of casing 10 to assist in the gripping of same when attaching or removing the casing to or from an associated electronic device, as hereinafter described. The ribs 16 are substantially parallel to one another and oriented such that adjacent ribs 16 are substantially equally angularly disposed on the outer surface of the casing 10.

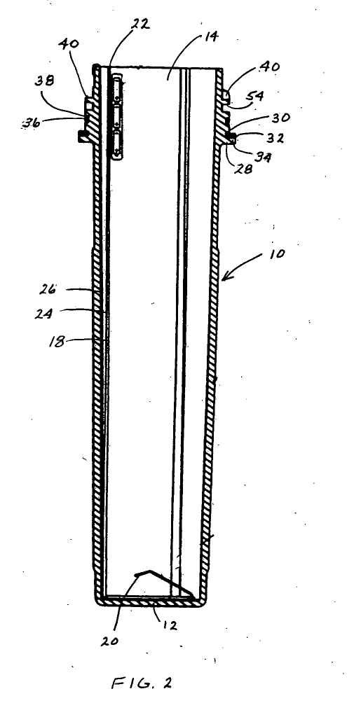

Referring now to FIG. 2, which is a cross-sectional view of casing 10, an electrical conductor 18 is received within casing 10 and is positioned therein such that its contact spring end portion 20 engages closed end 12 of casing 10 and its terminal end portion 22 is adjacent open end 14 of casing 10. Substantially straight conductor portion 24 of electrical conductor 16, which is interposed between and interconnects contact spring end portion 20 with terminal end portion 22, is positioned adjacent the inner wall 26 of casing 10.

An outwardly extending flange-shaped lip 28 is provided on casing 10 adjacent open end 14 thereof. A circumferential groove 30 is provided adjacent the top surface 32 of the outwardly extending flange-shaped lip 28 and a compression washer 34 is received within circumferential groove 30. Another circumferential groove 36 is provided in casing 10 adjacent open end 14 thereof and an O-ring 38 is received therein. Compression washer 34 and O-ring 38 can be made from EPDM material, or a similar material. A thin film of silicon grease is applied to the surfaces of compression washer 34 and O-ring 38 to assist in providing a watertight, submersible seal to the resulting assembly when the casing 10 is threadably attached to an associated electronic device, as hereinafter described. Two oppositely disposed male threads 40 are positioned on casing 10 adjacent open end 12 thereof. The male threads 40 have a substantially square cross-section.

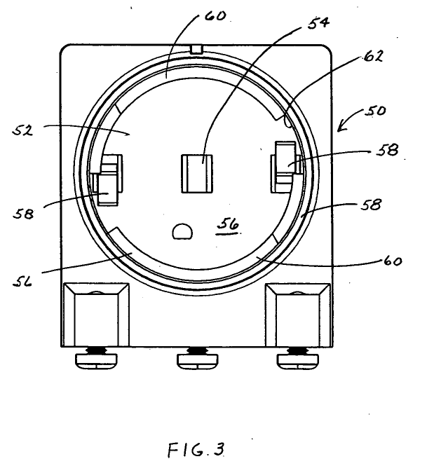

Referring now to FIG. 3, a bottom plan view of an electronic device 50 that can be threadably attached to casing 10 of the present invention to form an overall assembly is illustrated. The electronic device 50, which can also be made from any one of a number of injection moldable plastic materials, has a blind bore 52 therein sized so as to receive open end 14 of casing 10. A centrally located terminal 54 is provided in bottom surface 56 of blind bore 52 and oppositely disposed terminals 58 are similarly positioned in bottom surface 56 of blind bore 52. Oppositely disposed terminals 58 are electrically interconnected internally. Two oppositely disposed male threads 60 are positioned within blind bore 52 adjacent open end 62 of electronic device 50. The male threads 60 are substantially square in cross-section and have the same pitch as male threads 40 adjacent open end 14 of casing 10.

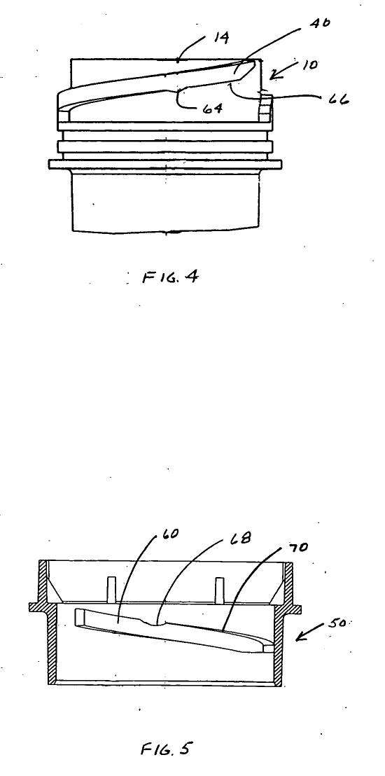

Referring now to FIG. 4 which is a front elevation view of the casing 10 of the present invention taken adjacent its open end 14 portion, a downwardly directed projection 64 is provided on the bottom surface 66 of male threads 40 that are provided thereon. As shown in FIG. 5, which is a cross-sectional view of the electronic device 50, a recess 68 is provided in the top surface 70 of male threads 60 that are provided therein. The recess 68 is sized so as to receive projection 64 to grippingly engage same when the casing 10 is threadably attached to the electronic device 50. It should be noted that the aforementioned projection and recess arrangement can be reversed, i.e., an upwardly directed projection (not shown) can be provided on the top surface 70 of male threads 60 provided on electronic device 50 and a recess (not shown) can be provided in the bottom surface 66 of male threads 40 provided on casing 10. Here again, the recess would be sized so as to receive the aforementioned projection to grippingly engage same when the casing 10 is threadably attached to the electronic device 50.

In order to attach casing 10 to electronic device 50, open end 14 of casing 10 is inserted into open end 62 of electronic device 50 and then turned so that bottom surface 66 of male threads 40 on casing 10 contacts the top surface 70 of male threads 60 within blind bore 52 in electronic device 50 and then rotated 90 degrees in order to firmly engage same. Engagement is maintained by the receipt of projection 64 provided on male threads 40 on casing 10 within recess 68 in male threads 60 provided within electronic device 50. After engagement, compression washer 34 contacts surface 72 of electronic device 50 and O-ring 38 contacts the inner surface defining blind bore 52 in electronic device 50 sealing casing 10 and electronic device 50. The silicon grease on compression washer 34 and O-ring 38 provide a watertight submersible seal for the assembly of the casing 10 and the electronic device 50. In this orientation, the negative terminal of the upper-most dry cell battery contacts centrally located terminal 54 in bottom surface 56 of blind bore 52 within electronic device 50 and terminal end portion 22 of electrical conductor 18 contacts one of the oppositely disposed terminals 58 in bottom surface 56 of blind bore 52 within electronic device 50.

Certain modifications and improvements will occur to those skilled in the art upon reading the foregoing. It is understood that all such modifications and improvements have been deleted herein for the sake of conciseness and readability, but are properly within the scope of the following claims.

I claim:

1) A watertight, submersible removable housing for a power source comprising a casing member having an open end and an oppositely disposed closed end, an electrical conductor received within said casing member and positioned therein so as to substantially engage said closed end of said casing member and extend to said open end of said casing member, said casing member having threads adjacent said open end, said threads having means formed therein permitting the frictional engagement of said threads on said casing member with threads on a mating component.

2) The housing as defined in claim 1 wherein said casing member is substantially tubular in configuration.

3) The housing as defined in claim 1 wherein said casing member is sized so as to receive at least one dry cell battery

4) The housing as defined in claim 3 wherein said at least one dry cell battery comprises a plurality of dry cell batteries.

5) The housing as defined in claim 1 further including a first sealing member received over said casing member and positioned adjacent said open end thereof.

6) The housing as defined in claim 5 wherein said first sealing member is a compression washer.

7) The housing as defined in claim 1 further including a second sealing member received over said casing member and positioned adjacent said open end thereof.

8) The housing as defined in claim 7 wherein said second sealing member is an O-ring.

9) The housing as defined in claim 1 further including a first sealing member received over said casing member and positioned adjacent said open end thereof and a second sealing member received over said casing member and positioned so as to be interposed between said first sealing member and said open end of said casing member.

10) The housing as defined in claim 9 wherein said first sealing member is a compression washer and said second sealing member is an O-ring.

11) The housing as defined in claim 1 wherein said frictional engagement means in said threads comprises a projection on said threads.

12) The housing as defined in claim 1 wherein said frictional engagement means in said threads comprises a recess in said threads.

13) The housing as defined in claim 1 wherein said threads have a substantially square cross-section.

14) A housing for a power source and an associated electronic device, in combination, providing a watertight, submersible assembly comprising a casing member having an open end and an oppositely disposed closed end, an electrical conductor received within said casing member and positioned therein so as to substantially engage said closed end of said casing member and extend to said open end of said casing member, said casing member having threads adjacent said open end, said electronic device having a recess therein sized to receive said open end of said casing member and having threads therein to engage said threads on said casing member, said electronic device having at least one electrical contact therein positioned so as to engage said electrical conductor in said casing member.

15) The combination as defined in claim 14 wherein said at least one electrical contact within said electronic device comprises two oppositely disposed spaced-apart electrical contacts.

16) The combination as defined in claim 15 further including a substantially centrally positioned electrical contact within said electronic device, said substantially centrally positioned electrical contact being interposed between said two oppositely disposed spaced-apart electrical contacts.

17) The combination as defined in claim 14 wherein said threads on said casing member and said threads on said electronic device have substantially the same pitch.

18) The combination as defined in claim 17 wherein said threads on said casing member and said threads on said electronic device are substantially square in cross-section.

19) The combination as defined in claim 17 wherein said pitch of said threads on said casing member and said threads on said electronic device is such that rotation of said open end of said casing member within said recess in said electronic device by about 90 degrees causes said threads on said casing member to engage said threads in said electronic device.

20) The combination as defined in claim 14 wherein said casing member is substantially tubular in configuration.

21) The combination as defined in claim 14 wherein said casing member is sized so as to receive at least one dry cell battery.

22) The combination as defined in claim 21 wherein said at least one dry cell battery comprises a plurality of dry cell batteries.

23) The combination as defined in claim 14 further including a first sealing member received over said casing member and positioned thereon so as to contact the surface of said electronic device.

24) The combination as defined in claim 23 wherein said first sealing member is a compression washer.

25) The combination as defined in claim 14 further including a second sealing member received over said casing member and interposed between the outer surface of said casing member and the surface defining said recess in said electronic device.

26) The combination as defined in claim 25 wherein said second sealing member is an O-ring.

27) The combination as defined in claim 14 further including a first sealing member received over said casing member and positioned so as to contact the surface of said electronic device and a second sealing member received over said casing member and interposed between the outer surface of said casing member and the surface defining said recess in said electronic device.

28) The combination as defined in claim 27 wherein said first sealing member is a compression washer and said second sealing member is an O-ring.

29) The combination as defined in claim 14 further means for frictional engaging said threads in said casing member and said threads in said electronic device.

30) The combination as defined in claim 29 wherein said frictional engaging means for said threads comprises a projection on said threads on said casing member and a recess in said threads in said electronic device, said recess in said threads in said electronic device being sized so as to receive said projection on said threads on said casing member.

31) The combination as defined in claim 29 wherein said frictional engaging means for said threads comprises a projection on said threads in said electronic device and a recess in said threads on said casing member, said recess in said threads on said casing member being sized so as to receive said projection on said threads in said electronic device.
